(19) United States
(12) Patent Application Publication
(10) Pub. No.: US 2003/0161955 A1
(43) Pub. Date: Aug. 28, 2003

(54) Method and system for coating

(75) Inventor: Ross D. Brumwell, Jameston (GB)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/370,801

(22) Filed: Feb. 20, 2003

(30) Foreign Application Priority Data
Feb. 26, 2002 (GB) 0204390.9

(51) Int. Cl. B05D 3/12

(52) U.S. Cl. 427/348; 118/56; 118/58

(57) ABSTRACT

The invention provides a method and system for coating a web. The method comprises the steps of (a) applying a coating material to a surface of the moving web at an application point; and then, (b) directing a jet of gas towards each surface of the web simultaneously at least one of the edges of the web to remove a portion of the coating material from said at least one edge. This enables a substantially uniform coating to be formed over the entire width of the web.

This is a U.S. Original patent application which claims priority on United Kingdom Patent Application No. 0204390.9 filed Feb. 26, 2002.

### FIELD OF THE INVENTION

The present invention relates to a method and system for coating a web. In particular the invention relates to a method and system for coating a web with a material as used in, for example, the manufacture of photographic material such as film or paper.

### BACKGROUND OF THE INVENTION

In the manufacture of photographic material such as film or paper a gelatin solution is applied onto a base material. In the manufacture of graphics film, gelatin solution is coated onto a base such as a Polyethylene Terephthalate (PET) base or web. The gelatin coating enables photosensitive emulsions applied in subsequent processing steps, to adhere to the web. FIG. 1 shows an example of part of the coating apparatus used in conventional skim pan coating of a gelatin solution on a PET base. The apparatus comprises a subbing drum 2 arranged to define the passage for a web 4 to be coated through a vessel (gel pan 6) containing gelatin solution 7.

As the web 4 passes through the gel pan 6 surface tension between the web 4 and gelatin solution 7 cause the gelatin to be coated onto the first surface of the web 4 (see FIG. 2). The gelatin solution 7 clings to the web 4 as it passes through the gel pan 6. This establishes a gelatin coating across the entire width of the web 4 being coated. The coating is initially non-uniform and so an air knife 8 is provided to blow excess solution off the web and back into the gel pan 6 for re-use. Typically, the coating process is continuous, running 24 hours a day 7 days a week.

After the web 4 has passed through the gel pan 6 and picked up the coating material (gelatin solution) it proceeds to a dryer stage 9 in which the coating on the first coated surface of the web 4 is dried. The dryer stage 9 has a number of guide rollers e.g. 10 and 12 arranged to guide the web 4 through a heated passage to give the gelatin coating time to dry. Once the gelatin coating has dried, the web 4 is directed to a second subbing roller 14 arranged in a second gel pan 16, to coat the second, opposite, surface of the web 4. After the web 4 has passed through the second gel pan 16 and the second surface of the web 4 has been coated it proceeds to a second dryer stage 18 in which the coating on the second coated surface of the web 4 is dried. Like the first dryer stage 9, the second dryer stage 18 has a number of guide rollers 21 and 23 arranged to guide the web through a heated passage to give the gelatin coating time to dry.

A problem that occurs is that any undried material can become detached from the web 4 and be deposited on the guide rollers where it hardens. Guide rollers 10 and 21 are particularly prone to this problem since they are the first rollers that the newly-coated web encounters during its passage through the respective first and second dryer stages.

After a period of time the build-up of coating material on the guide rollers becomes too great and the rollers can mark the web 4. This can cause an appearance defect on the web, which is unacceptable. To address this, periodically, say every 12 hours, coating stops and the rollers in the dryer stages are cleaned. However, this is expensive as the PET base material that passes through the system during the time when the rollers in dryer stages are being cleaned, is wasted. In addition no good product is made during this time.

A method and system of coating is required that overcomes this problem.

### SUMMARY OF THE INVENTION

According to a first aspect of the present invention, there is provided a method of coating a web, comprising the step of (a) applying a coating material to a surface of the moving web at an application point. The method then comprises the step of (b) directing a jet of gas, such as air, towards each surface of the web simultaneously at least one of the edges of the web to remove a portion of the coating material from said at least one edge.

Preferably, the method further comprises, between steps (a) and (b), the step of removing a portion of the coating material across the width of the web. This ensures that with the exception of the edges of the web, the web is substantially uniformly coated prior to interaction with the jet of air directed towards each surface of the web.

Preferably, the step of applying a coating material to the moving web comprises routing the web through a vessel containing the coating material in liquid form. The liquid may be liquid gelatin or any other suitable coating material.

In one example, a web router (such as a routing drum) for routing the web through the vessel containing coating material is provided at a predetermined height relative to the liquid coating material in the vessel. This ensures that as the web passes through the vessel a layer of coating material is picked up by surface tension and coated onto the web.

In one example, opposed air knives are used to provide the jets of gas or air. It is preferred that the air knives are controlled such that the jet of air that each provides contacts the web at a common position on opposite surfaces of the web thereby to ensure that the edge of the web does not flap as it passes the air knives. In other words, the point or line of impingement between the air jet and the web is arranged to be at the same distance from the web edge on both surfaces of the web.

The velocity of the air in each of the air jets is between 50 and 200 m/s. The length of the air jets is preferably between 50 and 200 mm and the width of the air jet is preferably between 0.5 and 1.5 mm.

Preferably, the method further comprises the step of detecting the thickness of the edge of the coated web, upstream or downstream of the position at which the jets of air are incident against the web. One or more parameters of the air jets is controlled in dependence on the detected thickness. Preferably, the parameter of the air knives is selected from the group consisting of the position of the air knives relative to the web, the angle of incidence between the air jet provided by the air knives and the web, the speed of the air jet and the width of the air jet.

According to a second aspect of the present invention, there is provided a system for coating a moving web. The system comprises routing means e.g. a routing drum or any other suitable routing means, for routing the web past a coating application point at which coating material impinges on the web. The system also includes at least one pair of gas jet producing means e.g. air knives, each of which is arranged to provide a jet of gas to strike the web at an edge position to remove a portion of the coating material.

In one example, the routing drum is a subbing drum arranged to route the web through a vessel containing the coating material.

Preferably, the system further comprises an air knife arranged up stream of the opposed gas jet producing means and transverse to the direction of movement of the web. The air knife is adapted to ensure that the web is substantially uniformly coated prior to interaction with the opposed gas jet producing means. The air knife is not able to accurately control the thickness of the web at the edge due to surface tension effects between the web and the coating material.

Preferably, the opposed gas jet producing means are moveable relative to the web. In one example, they are moveable such that the angle of incidence between the gas jets and the web can be adjusted. The gas jet producing means may also be moveable, for example, to increase the distance between the web and the gas jet producing means so that the relative force of the gas jet is reduced.

It is preferred that the gas jet producing means e.g. air knives are arranged and/or controlled such that the jet of gas e.g. air that each provides contacts the web at a common position on opposite surfaces of the web. This ensures that the web does not flap as it passes the air knives, which can cause turbulence and a lack of uniformity in the coating thickness.

Preferably, each of the gas jet producing means is adapted to provide a jet of gas having a velocity between 50 and 200 m/s. The length of a cross section through the gas jets is preferably between 50 and 200 mm and the width of the cross section is preferably between 0.5 and 1.5 mm, most preferably 0.9 mm.

In one example of the present invention, the system comprises a sensor upstream of the gas jet producing means arranged to detect the thickness of the edge of the coated web. The sensor provides a signal to an associated control unit to control the gas jet producing means in dependence on the detected thickness. If it is detected that the thickness of the edge of the web is outside a predetermined range a parameter of the gas jet producing means is adjusted. The parameter is selected from the group consisting of the position of the gas jet producing means relative to the web, the angle of incidence between the gas jet provided by the gas jet producing means and the web, the speed of the gas jet and the width of the gas jet.

The associated control unit may be a dedicated control unit such as a microprocessor. Alternatively, a computer program running on an associated control computer can provide control.

### ADVANTAGEOUS EFFECT OF THE INVENTION

The invention provides a method and system that is able to produce uniformly coated web. In particular, the invention provides a method and system that is capable of ensuring that an excess of coating material is not allowed to remain on the edge of a coated web. As explained above, if an excess of coating material is allowed to remain on the edge of a coated web, after a period of time there is a build up of coating material on guide rollers within an associated dryer stage which becomes too great causing the rollers to mark the web.

To stop the build up of coating material reaching the stage at which marking of the web occurs, periodically, coating stops and the rollers in the dryer stage are cleaned. This causes wastage, which is undesirable. The present invention provides a method and system that overcomes these problems.

In the case where the gas jet producing means are controlled such that the jet of gas that each provides interacts with the web at common positions on opposite surfaces of the web, this ensures that the edge of the web does not flap as it passes the air knives. This is advantageous since flapping of the web edge causes irregularities in the coating thickness at the web edge, which can thus be minimised.

In one example a sensor is used to detect the thickness of the coated web and provide a control signal to the gas jet producing means in dependence thereon. In this case, it is possible to automatically control the thickness of the web edge, which is desirable.

The invention provides a simple and robust method for ensuring that the thickness of the coated web is maintained uniform across the entire width of the web. Where feedback is used between a sensor and the gas jet producing means, the system and method serve to reduce automatically the frequency at which the guide rollers require cleaning. Thus wastage is reduced and efficiency of the coating process is increased.

### BRIEF DESCRIPTION OF THE DRAWINGS

Examples of the present invention will now be described in detail with reference to the accompanying drawings, in which:

FIG. 1 shows an example of part of the coating apparatus used in conventional gelatin coating of a PET base;

FIG. 2 shows a perspective view of part of the coating apparatus shown in FIG. 1, used in conventional skim pan air knife coating;

FIGS. 3A and 3B show respectively a perspective and section view of the edge of a material coated using the system shown in FIG. 2;

FIG. 4 shows an example of part of a coating apparatus according to the present invention;

FIGS. 5a and 5b show sections along the lines II and I′I′ in FIG. 4, respectively

FIG. 6 shows a section through a material coated according to the method of the present invention;

FIG. 7 shows an example of a first control system for use with the coating system of the present invention; and,

FIG. 8 shows an example of a second control system for use with the coating system of the present invention.

### DETAILED DESCRIPTION OF THE INVENTION

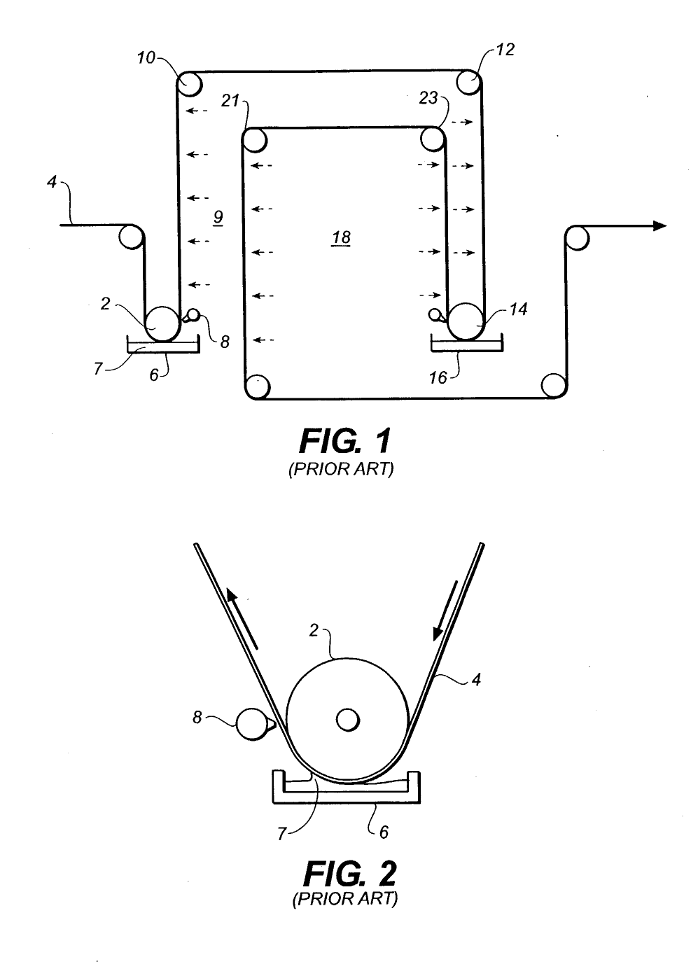

FIGS. 1 and 2 show an example of part of a conventional skim pan coating apparatus used for double-sided coating of a web 4. As explained above, the apparatus used in a conventional skim pan coating process, typically comprises a first coating stage having a subbing drum 2 arranged to define the passage for a web 4 to be coated through a vessel (gel pan 6) containing gelatin solution 7. The subbing drum 2 serves as routing means to route the web 4 through the gel pan 6.

As the web 4 passes through the gel pan 6, surface tension (as shown in FIG. 2) between the web 4 and gelatin solution 7 cause the gelatin to be coated onto the first surface of the web 4. The gelatin 7 solution clings to the web 4 as it passes through the gel pan 6. This establishes a gelatin coating across the entire width of the web 4 being coated. An air knife 8 is provided to blow excess solution off the web and back into the gel pan 6 for re-use.

After the web 4 has passed through the gel pan 6 and picked up the coating material (gelatin solution) it proceeds to a dryer stage 9 in which the coating on the first coated surface of the web 4 is dried. The dryer stage 9 has a number of guide rollers arranged to guide the web 4 through a heated passage to give the gelatin coating time to dry. Once the gelatin coating has dried, the web 4 is directed by to a second coating stage having a second subbing roller 14 arranged in a second gel pan 16, to coat the second, opposite, surface of the web 4 in a corresponding manner. A control computer (not shown) is used to control the coating process.

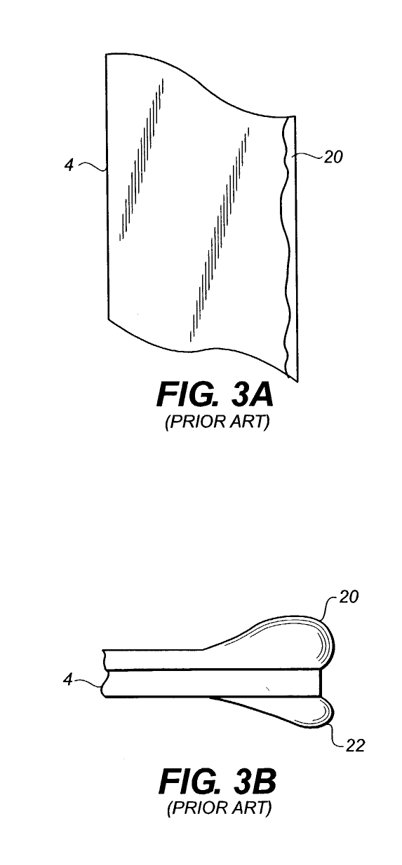

FIGS. 3A and 3B show respectively a perspective and section view of the edge of a material coated using the system shown in FIGS. 1 and 2. A bead 20 of gelatin solution builds up on the edge of the web as it is coated due to the surface tension between the web 4 and the coating material. It is this bead which contributes to the problem of hardening material formed on the guide rollers in the respective dryer stages.

If the bead of gelatin 20 is thicker than the otherwise uniform coating of gelatin on the rest of the web it does not dry sufficiently. Accordingly as the coated web passes over the guide rollers, material that has not yet dried is deposited on the guide rollers. In the case of coating a PET web with a gelatin solution the bead size may vary from, say, 30 to 100 microns. In some situations if the coating system is not functioning as desired the bead may be up to 400 or 500 microns in thickness. This is substantial in comparison to the thickness of the coating itself, which is preferably between 0.06 and 0.3 microns.

In addition there is a build-up 22, during the passage of the web through the gel pan 6, of material at the edge of the opposite surface of the web 4. This causes problems since the dryer stages 9 and 18 are not adapted to dry material on the opposite surface of the web. Each of the dryer stages 9 and 18 is adapted to dry the surface most recently coated prior to the entry of the web into the respective dryer stage.

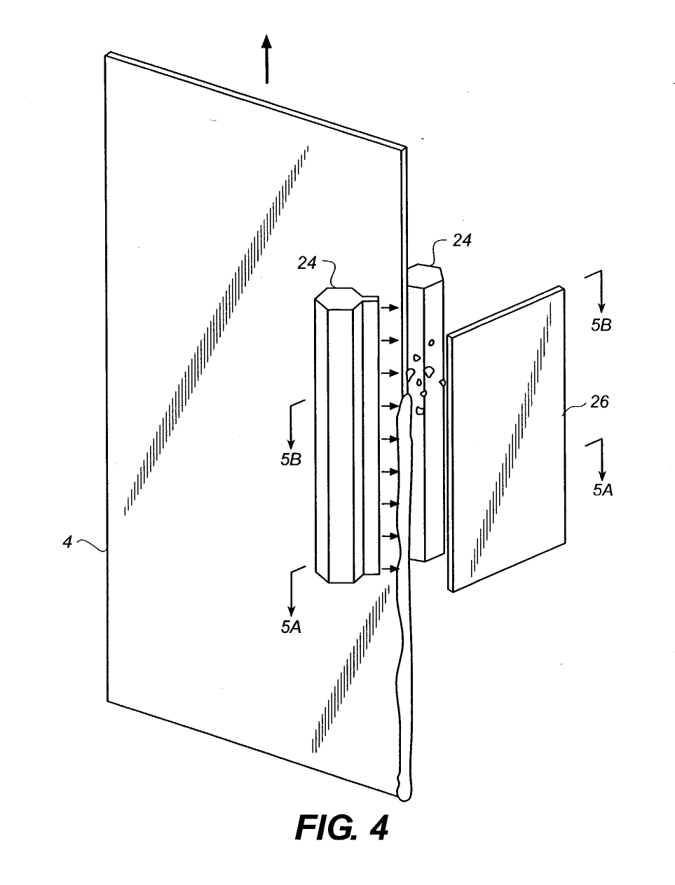

FIG. 4 shows an example of a coating apparatus according to the present invention. In addition to the features of the coating system shown in FIGS. 1 and 2, the system comprises at least two opposed gas jet producing means, in this case air knives 24. The air knives serve to provide a jet of gas (in this case air) of suitable dimensions and/or force and/or velocity to remove a desired portion of coating material from the web edge. Preferably, one pair of the gas jet producing mean are provided for each edge of the web.

Where air knives are used, the air knives are arranged to direct a jet of air onto both surfaces of at least one, preferably both, of the edges of the web 4 as it passes between them. The air knives are arranged such that orientation of the jet of air each produces serves to blow off a portion of the coating material from the web edge. It is preferred that their ‘blades’ are substantially parallel to the direction of movement of the web 4. Any suitable gas e.g. an inert gas, may be used in place of air to remove a predetermined portion of the coating material.

The air knives are also arranged so that one of the pair directs a jet of air onto a first surface of the web and the other one of the pair directs a jet of air onto the opposite surface of the web such that the two air jets strike the web surface at a corresponding point or line. It is preferred that the point or line at which the second air jet strikes the surface of the web is sufficiently close to the point or line at which the first air jet hits the opposite surface to ensure that the edge of the web is effectively clamped. This serves to reduce flapping of the edge of the web.

The air jets remove the excess material in the beads 20 and 22 so that drying can occur as it does for the rest of the web. A pad 26 is provided to absorb the removed material. In place of the pad a vessel may be provided to receive the removed material for recycling. The pad 26 may be made of any suitable absorbent material and is preferably interchangeable so that when a first pad becomes soaked with coating material removed from the web, a subsequent pad can be easily put in its place. Preferably, housing or bracket means (not shown) is provided to support the pad in its operative position. The housing has a suitable catch mechanism with which a pad to be used engages. A used pad can therefore easily be disengaged from the housing thus making the process of changing one pad for another simple.

In place of an absorbent pad it is possible to use a suction device such as a duct having at one end an opening for receiving removed coating material. The second end of the duct is connected to a vacuum source. In the case of an absorbent pad being used, when material is blown off the web by the air knives 24, it passes for a short time through the air until it impacts against the pad surface and is absorbed. In the case of a suction device, the pad is replaced with the opening of a duct, which serves to attract the removed material as it passes through the air between the opening and the web.

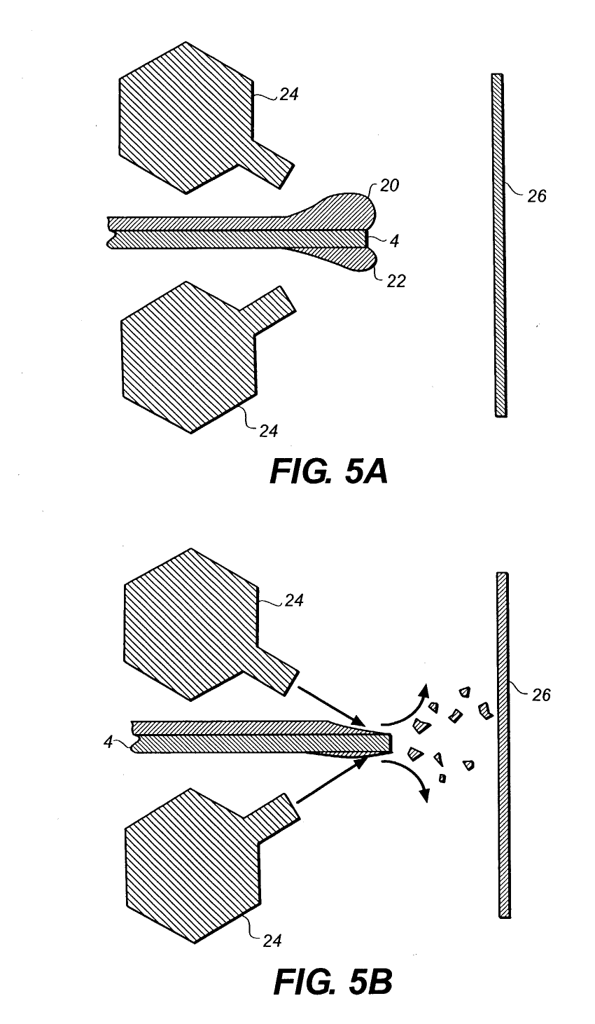

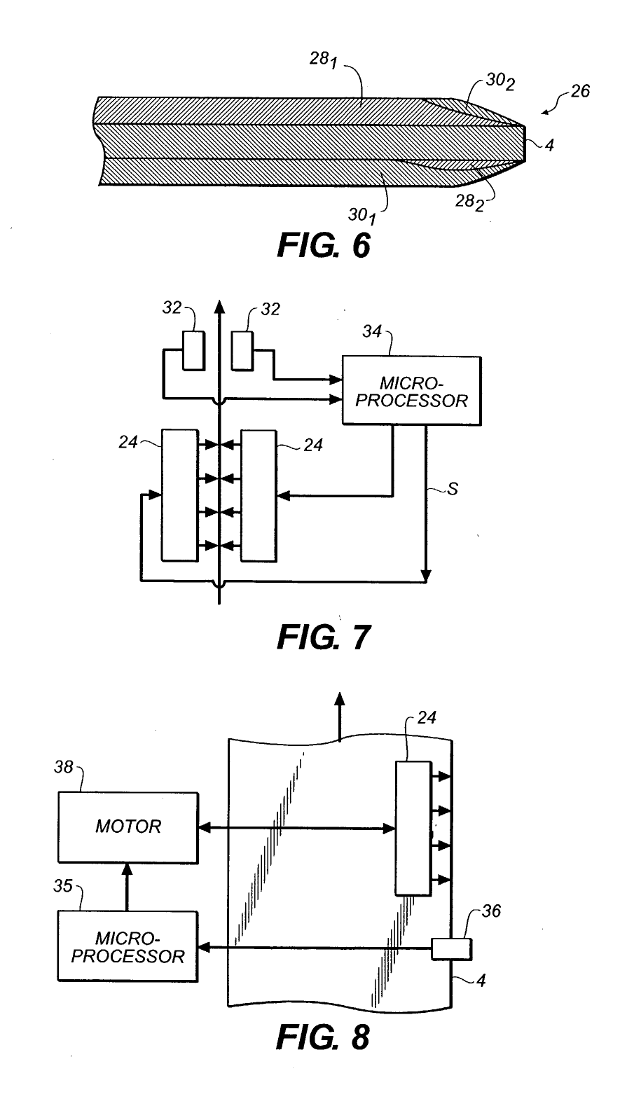

FIGS. 5a and 5b show sections through the web in two stages, one immediately prior to entering a space between the air knives 24 (along line II in FIG. 4) and one immediately after having passed between the air knives 24 (along line 1′1′ in FIG. 4). In the first of the two cases, the beads 20 and 22 of liquid gelatin can be seen clearly formed on both surfaces of the web 4. After the web 4 has passed between the air knives 24, the beads 20 and 22 are substantially removed. The thickness of the material on the coated surface of the web 4 tapers towards the edge of the web. The profile of the material on the reverse side of the web is substantially reduced. As will be explained below with reference to FIG. 6, once the opposite surface of the web has been coated, the profile of the coating will be substantially uniform across the entire width of the web.

The air knives are arranged at a position such that the jet of air they each produce serves to blow any excess material forming the beads 20 and 22 off the web. Adjusting, for example, the speed at which air is blown from the knives or the thickness of the jet of air can control the force provided by the air knives. Alternatively, the angle of incidence between the air jet and the web may be adjusted as desired. The advantage of providing an air knife on both sides of the web is that flapping of the web as it passes between the air knives is avoided. This is because the web, as it passes between the air knives 24, is effectively clamped between the air jets provided by the opposing air knives. In the absence of such an arrangement the web would flap creating turbulence. The turbulence adversely affects the uniformity of the thickness of the coating at the edge of the web and across the entire width of the web at the position of the flapping.

FIG. 6 shows a section through a material coated according to the method of the present invention. The coated material 26 has a web substrate 4 with coatings applied to both sides. The coating is made up of a number of component coating sections 28₁, 28₂, 30₁ and 30₂. Sections 28₁ and 28₂ are the product of coating by first coating stage. The coating material 28₁ is arranged predominantly on the first surface of the web. An amount 28₂ of coating material is also present on the second opposite surface of the web as explained above. Sections 30₁ and 30₂ are the product of coating by second coating stage.

In this case, the coating material 30₁ is arranged predominantly on the second surface of the web although an amount 30₂ of coating material is also present on the first surface of the web. It can be seen that the overall effect is to provide a substantially uniform coating across the entire width of the web.

In one example a coating of a gelatin solution is applied. In this case, typically the web is between 1100 mm and 1400 mm wide and between 90 and 110 microns thick. The beads 20 and 22 may typically have a thickness of between 30 and 100 microns. The present invention enables the beads to be removed and a coating of between 0.3 and 0.06 microns to be accurately provided across the entire width of the web avoiding substantially larger coating thickness at the web edge. In other examples, for example where a web is coated with one or more viscous emulsion layers as in the manufacture of photographic material, the average coating thickness is substantially thicker. For example, in the coating of sensitised product the average coating thickness laid down is between 35 and 100 microns.

The present invention has so far been described with reference to a coating process in which the point of impingement between the coating material and the web to be coated is within a vessel that contains the coating material (see gel pan 6 in FIGS. 1 and 2). The invention also applies to other coating methods where the problem of build-up of coating material on guide rollers, such as the guide rollers in an associated dryer stage, exists. For example in a curtain coating method it is possible that a build up of material at the web edge may lead to the same problem of build-up of coating material on the associated guide rollers. Similarly, the invention applies to bead coating or any other type of coating in which the problem is encountered.

As mentioned above, the subbing drum serves as routing means to route the web 4 through the gel pan 6. It may therefore be replaced with any suitable device for routing the web through the gel pan 6. In methods of coating other than skim pan air knife coating, the subbing drum may be replaced with any suitable device for routing the web past a coating application point at which coating material impinges on the web. Examples include an air bar having a smooth curved shaped surface to define a route for the web 4 through the gel pan 6. The surface of the air bar is provided with a plurality of holes through which pressurised air is forced such that although the web moves relative to the air bar it does not actually contact the air bar.

In a preferred embodiment of the present invention a control system is provided to adjust automatically a parameter of the air knives to ensure that the thickness of the coated web edge is maintained at a substantially constant value. FIG. 7 shows a schematic representation of the control system. The system has a sensor 32 arranged downstream of the air knives 24. The sensor 32 is coupled to a microprocessor 34, or any other suitable control unit, and is adapted to detect the thickness of the edge of the coated web. The sensor 32 may be provided either upstream or downstream of the air knives 24 relative to the movement of the web 4.

Examples of suitable sensors include, amongst others, optical sensors, ultrasonic sensors or capacative sensors arranged to monitor the thickness of the edge of the coated web as it passes through. In the example shown, the air knives 24 will previously have acted on the edge of the web to remove unwanted coating material, as explained above.

The microprocessor 34 is arranged to provide a control signal S to the air knives 24 to control their operation in dependence on the signal received from the sensor 32. For example, if the air knives 24 have not removed enough of the material, the sensor detects the fact that edge of the web is too thick. In this case a control signal is sent to the air knives to adjust a parameter of the air knives to ensure that a greater proportion of the material is removed. In one possible example, the signal causes an increase in the speed of the air jet provided by the air knives. Alternatively, it could cause a variation in the position of the opposed air knives relative to each other and/or the edge of the coated web 4 so that the air jets are more effective.

A predetermined trigger value at which the signal S is sent to the air knives is set in dependence on the particular coating system and required tolerance. For example, if the desired thickness of the coated web is 100 microns, an error signal may be generated when it is detected that the thickness of the web edge is greater than 103 microns or less than 97 microns.

It is possible that during passage of the web through the coating system, the web tracks from side to side i.e. moves in a direction perpendicular to the intended direction of motion of the web through the system. From a central position in which the web edge is correctly aligned with the air knives, tracking of up to 20 mm each way is possible. If tracking occurs, the edge of the web may not remain aligned with the air knives 24, as desired. Accordingly the point of impingement between the jet of air from the air knives 24 and the web varies. This can effect the efficiency with which coating material is removed from the edge of the web. For example, if the jet of air impinges too close to the centre of the web i.e. in from the edge, it may be necessary to increase the speed of the air jet and/or decrease the speed of passage of the web, both of which are undesirable.

FIG. 8 shows an example of a second control system for use with the coating system of the present invention that addresses this. The control system comprises a position sensor 36 arranged, in this example, upstream of the air knives 24. The sensor 36 is coupled to a control unit 35 and provides a signal to the control unit 35 in dependence on the position of the web edge. As the web tracks, the signal provided by sensor 36 to control unit 35 varies in dependence on the position of the web edge. Examples of suitable types of sensor 36 include, but are not limited to, capacative sensors, optical sensors, ultrasonic sensors or any other sensor capable of detecting the varying position of the edge of the web and providing a corresponding signal to the control unit 35. Like the sensor 32 in FIG. 7, the sensor 36 may be provided either upstream or downstream of the air knives 24 relative to the movement of the web 4.

The control unit 35 is coupled to a drive system 38 to control the position of the air knives 24. The drive system may be any system capable of adjusting the position of the air knives 24 relative the web edge. Examples include, amongst others, an electric motor or a hydraulic drive. The drive system may be adapted to move the air knives in synchronisation with the tracking of the web such that the relative position of the air knives 24 and the web edge remains unchanged. Alternatively, the drive system may be adapted to drive a change in a different selected parameter of the air knives such that the amount of material removed from the web remains constant as described above with reference to FIG. 7.

The control unit 35 may be a dedicated microprocessor or any other suitable control unit. A common control unit may be used to serve the functions of the control units 34 and 35 in the control systems of each of FIGS. 7 and 8. Alternatively, one or both of the control systems of FIGS. 7 and 8 may be implemented via the overall control computer used to control the entire coating process.

The present invention has been described with reference to the coating of a PET web with gelatin. It will be appreciated that the method and system applies equally to any suitable coating system in which a base material is coated with coating material. Examples include, but are not limited to, curtain coating or bead coating (both of which are used in the manufacture of sensitised photographic material), fountain coating, pond distribution coating, or any other suitable type of coating.

The invention provides a method and system that is able to produce uniformly coated web. In particular, the invention provides a method and system that is capable of ensuring that an excess of coating material is not allowed to remain on the edge of a coated web, thereby reducing waste in a coating process.

What is claimed is:

1. A method of coating a moving web, comprising the steps of:
(a) applying a coating material to a surface of the moving web at an application point; and
(b) directing a jet of gas towards each surface of the web simultaneously at least one of the edges of the web to remove a portion of the coating material from said at least one edge.

2. A method according to claim 1, further comprising, between steps (a) and (b), the step of removing a portion of the coating material across the web to ensure that the web is substantially uniformly coated prior to interaction with the jet of gas directed towards each surface of the web.

3. A method according to claim 1, in which the step of applying a coating material to the moving web comprises routing the web through a vessel containing the coating material in liquid form.

4. A method according to claim 3, in which a web router is provided to route the web through the vessel containing the coating material, the web router being provided at a predetermined height relative to the liquid coating material in the vessel, such that as the web passes through the vessel a layer of coating material is picked up by surface tension and coated onto the web.

5. A method according to claim 1, in which the gas is air and opposed air knives are used to provide the jets of air to remove the portion of coating material.

6. A method according to claim 5, in which the air knives are controlled such that the jet of air that each provides interacts with the web at common positions on opposite surfaces of the web thereby to ensure that the web does not flap as it passes the opposed air knives.

7. A method according to claim 1, in which each gas jet has a speed between 50 and 200 m/s.

8. A method according to claim 1, further comprising the step of detecting the thickness of the edge of the coated web at a position other than the position at which the jets of gas are incident against the web and controlling one or more parameters of the jets of gas in dependence thereon.

9. A method according to claim 8, in which the parameter of the jets of gas is selected from the group consisting of the position of the source of the jets relative to the web, the angle of incidence between the gas jets and the web, the speed of the gas in the gas jet and the width of the gas jet.

10. A system for coating a moving web, comprising:
routing means for routing the web past a coating application point at which coating material impinges on the web; and
at least one pair of opposed gas jet producing means, each arranged to provide a jet of gas to strike the web at an edge position on opposite surfaces of the web to remove a portion of the coating material.

11. A system according to claim 10, in which the gas is air and the gas jet producing means are air knives.

12. A system according to claim 10, in which the routing means is a drum arranged to route the web through a vessel containing the coating material.

13. A system according to claim 10, further comprising an air knife arranged up stream of the opposed gas jet producing means and transverse to the direction of movement of the web, adapted to ensure that the web is substantially uniformly coated prior to interaction with the opposed gas jet producing means.

14. A system according to claim 10, in which the opposed gas jet producing means are moveable relative to the web such that the angle of incidence between the gas jets and the web can be adjusted.

15. A system according to claim 10, in which the opposed gas jet producing means are controlled such that the jet of gas that each provides contacts the web at a common position on opposite surfaces of the web thereby to ensure that the web does not flap as it passes the gas jet producing means.

16. A system according to claim 10, further comprising one or more absorbent pads positioned to receive the removed coating material.

17. A system according to claim 10, in which each of the gas jet producing means is adapted to a provide a jet of gas having a speed between 50 and 200 m/s.

18. A system according to claim 10, comprising a sensor upstream of the gas jet producing means arranged to detect the thickness of the edge of the coated web and provide a signal to an associated control unit to control the gas jet producing means in dependence on said detected thickness.

19. A system according to claim 18, in which, if it is detected that the thickness of the edge of the web is outside a predetermined range a parameter of the opposed gas jet producing means is adjusted, the parameter being selected from the group consisting of the position of the gas jet producing means relative to the web, the angle of incidence between the gas jet and the web, the speed of the gas jet and the width of the gas jet.

20. A system according to claim 10, comprising a sensor arranged to detect the position of the web edge and provide a signal to an associated control unit to control the gas jet producing means in dependence on said detected position of the web edge.

21. A system according to claim 20, in which, if it is detected that the position of the web edge has moved, the gas jet producing means are moved by a corresponding amount to maintain alignment between the gas jet producing means and the web edge.
